(19) United States
(12) Patent Application Publication
(10) Pub. No.: US 2019/0122496 A1
(43) Pub. Date: Apr. 25, 2019

(54) SOFTWARE AND METHODS FOR DETERMINING AND CONFIRMING CASINO PAYOUTS USING VIDEO ANALYTICS THROUGH VIDEO SURVEILLANCE

(71) Applicant: Valentin Ionut Badoiu, Bucuresti (RO)

(72) Inventor: Valentin Ionut Badoiu, Bucuresti (RO)

(21) Appl. No.: 15/792,395

(22) Filed: Oct. 24, 2017

(51) Int. Cl. G07F 17/32; G06K 9/00

(52) U.S. Cl. CPC G07F 17/3248; G06K 9/00771; G06K 9/00718; G07F 17/322

(57) ABSTRACT

A system is able to learn, memorize and recognize the color and its value of any casino chip thru a video signal, and capable to identify and reconstruct partial visible casino chips on the betting area. The system can identify the bets made, identify the value of the bet, determine the odds for the bet, and determine the payouts for any winning bets. The system can include a display at the game table to provide the dealer, and optionally, the players, the payout amount of any winning bets for each player. The system may further save video and/or images of the entire betting layout for each game, such as for each individual spin in roulette, for guest dispute purposes, for statistical reports purposes and for later review with dealers should unintentional errors be made. The system can be programmed to determine payouts for a variety of casino games.

### BACKGROUND OF THE INVENTION

### 1. Field of the Invention

One or more embodiments of the invention relates generally to automated casino applications. More particularly, the invention relates to systems and methods for determining and confirming casino payouts using video analytics through video surveillance.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Casino games are designed to provide an advantage to the house. Therefore, the more games played or bets made, the greater the earnings for the house.

The roulette game is typically one of the lowest paced games on the casino floor. This is due to the many different betting options available to players and the various odds applied to these various betting options. When a number comes out, a dealer must identify all winning bets for that number and pay out a player based on the bets. These winning bets may each have their own odds, where one number may need to get paid out at eight or more different odds values. The result is a lower number of games played per hour and, accordingly, less earnings for the house. Moreover, disputes with customers may arise, which can in effect halt play on the table. Finally, unintentional human error can occur when bets and payouts become more complex.

In view of the foregoing, it is clear that there is a need for a system and method for automatically determining payouts for each player in a casino game, such as roulette.

### SUMMARY OF THE INVENTION

Embodiments of the present invention provide a system for determining payouts in a casino game, comprising a camera capturing images of a betting area of the casino game; a computing device receiving images captured by the camera; software stored on non-transient computer readable media on the computing device, the software including programming code to determine winning bets, determine an amount of bet for each of the winning bets, and calculate payouts for each of the winning bets; and a display at the casino game displaying the payouts for each of the winning bets as calculated by the software.

Embodiments of the present invention further provide a method for automatically determining payout in a casino game comprising capturing an image of a betting area of the casino game; receiving, by a computing device, the image of the betting area; determining, by analysis of the image by the computing device, one or more winning bets placed in the betting area; calculating, by the computing device, a payout for each of the winning bets; and displaying, to a dealer, each separate payout for each of the winning bets, where each payout is identified to a particular player.

Embodiments of the present invention also provide a method for automatically determining payout in a casino game comprising receiving, by a computing device, an image of a betting area of the casino game; determining each bet made on the betting area and an amount of each bet; notifying a dealer if a determination of each bet on the betting area is unclear; determining, by analysis of the image by the computing device, one or more winning bets placed in the betting area; calculating, by the computing device, a payout for each of the winning bets; and displaying, to the dealer, each separate payout for each of the winning bets, where each payout is identified to a particular player.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 is a schematic representation of a system for determining payouts for a casino game according to an exemplary embodiment of the present invention;

FIG. 2 is a flow chart describing a method for determining payouts for a casino game according to an exemplary embodiment of the present invention; and

FIG. 3 is a flow chart describing a method for monitoring and verifying payouts for a casino game according to an exemplary embodiment of the present invention.

Unless otherwise indicated illustrations in the figures are not necessarily drawn to scale. The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary, a variety of optional components are described to illustrate the wide variety of possible embodiments of the present invention.

A “computer” or “computing device” may refer to one or more apparatus and/or one or more systems that are capable of accepting a structured input, processing the structured input according to prescribed rules, and producing results of the processing as output. Examples of a computer or computing device may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” or “application” may refer to prescribed rules to operate a computer. Examples of software or applications may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java.™, Jini.™, C, C++, Smalltalk, Python, Perl, UNIX Shell, Visual Basic or Visual Basic Script, Virtual Reality Markup Language (VRML), ColdFusion.™ or other compilers, assemblers, interpreters or other computer languages or platforms.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The program code may also be distributed among a plurality of computational units wherein each unit processes a portion of the total computation.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G, 4G or the like.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

Embodiments of the present invention may include apparatuses for performing the operations disclosed herein. An apparatus may be specially constructed for the desired purposes, or it may comprise a general-purpose device selectively activated or reconfigured by a program stored in the device.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory or may be communicated to an external device so as to cause physical changes or actuation of the external device.

Broadly, embodiments of the present invention provide a system that is able to learn, memorize and recognize the color and its value of any casino chip thru a video signal, and capable to identify and reconstruct partial visible casino chips on the betting area. The present invention includes a method and system for identifying chips used for betting in a casino game and providing the dealer with any winning payouts during game play or after the play is completed. The system can identify the bets made, identify the value of the bet, determine the odds for the bet, and determine the payouts for any winning bets. The system can include a display at the game table to provide the dealer, and optionally, the players, the payout amount of any winning bets for each player. The system may further save video and/or images of the entire betting layout for each game, such as for each individual spin in roulette, for guest dispute purposes and for later review with dealers should unintentional errors be made. The system can be programmed to determine payouts for a variety of casino games.

The systems and methods of the present invention provides several benefits to the casino. For example, embodiments of the present invention can provide an increase number of roulette spins per hour, typically an increase of 20 percent or more. Embodiments of the present invention can also increase the speed of bet calculation, reduce human errors, minimize customer disputes, provide statistic reports and increases overall revenue for the house.

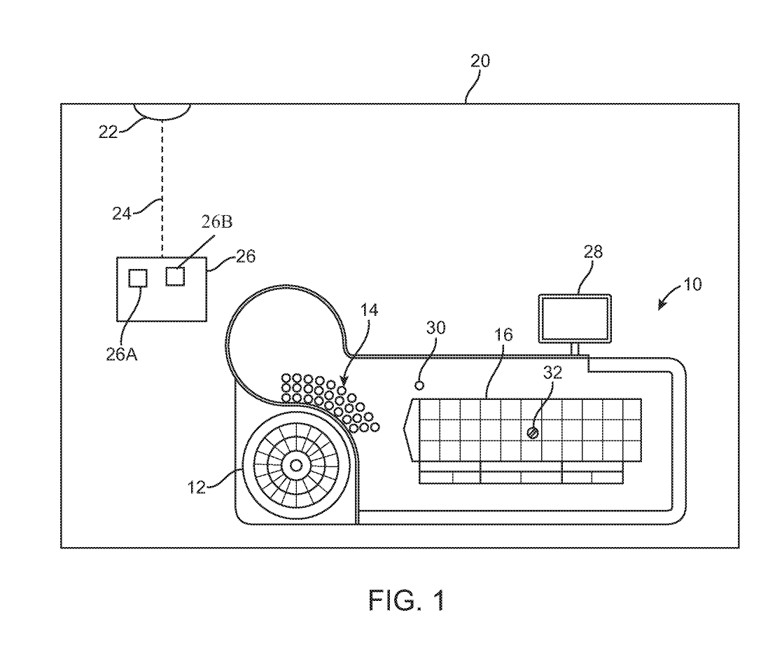

Referring now to FIG. 1, a casino game table, such as a roulette table 10 can include a roulette wheel 12, a plurality of payout chips 14 in various colors, and a betting area 16. In some embodiments, the betting area 16 may be a conventional roulette table, as shown, however, other casino table games may also utilize aspects of the present invention.

A system 20 according to aspects of the present invention, can include a video surveillance device, such as a video camera 22. The video camera 22 can view at least the betting area 16 and may further have a view of the roulette wheel 12, players at the table, or the like. The video camera 22 may be part of the casino's existing video surveillance system or may be a separate camera dedicated to the system 20.

A video feed, represented by dotted line 24, may be received by a computing device 26. The video feed may be sent via a wireless or wired signal connection. The computing device 26 may be programmed with data representing the odds of each available bet on the betting area 16. The computing device 26, at the end of game play, may include a processor 26A that can identify the winning number and any bets needing to be paid out based on the winning number. The computing device 26 may be programmed to reconstruct partially visible chip stacks as needed. The computing device 26 may further identify the player belonging to the chips and describe the payouts to the dealer and/or players on a display 28 based on the number of chips placed for each of the winning bets. The identification of the player may be simply by designated chip color, as in roulette, each player plays with their own specific chip color. In some embodiments, the identification of the player may be by seat number, player name (based on a rewards card provided, for example), or the like. The identification of the winning number may be based on the roulette wheel 12 or the placement of a marker dolly 32 on the betting area 16.

In some embodiments, when the computing device 26 is unable to accurately determine the specific bet, a message can be sent to the display 28 or an alert 30 may be provided to correct the bet placement. For example, if a user places three red chips on the number 3, but it is close to or partially on the corner, the computing device 26 may not be able to determine if the bet is for a single number (the number 3), paying 35:1, or for the four numbers on the corner (the numbers 2, 3, 5 and 6), paying 8:1. The computing device 26 may alert the dealer that the red chip bet near number 3 needs clarification, allowing the dealer to confirm with the player and better place the chips. This aspect of the present invention may help resolve player disputes as to the nature of the bet after the winning number is determined.

In some embodiments, the computing device 26 can monitor payouts and count chips paid out to each player to determine accuracy. In some embodiments, dealer errors may be saved and later provided to the dealer for feedback and improvement, while, in other embodiments, the computing device 26 may send a message to the dealer, immediately following payout, to check the number of chips paid out to player red, for example.

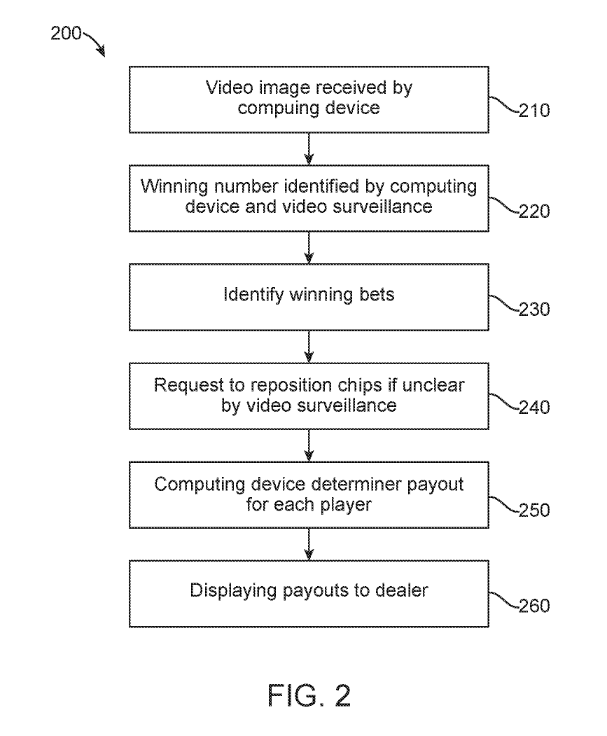

Referring now to FIG. 2, a method 200 for determining payouts is provided. In step 210, a video image is received by a computing device (such as computing device 26) once the betting is closed. The image may be stored in a memory (such as memory 26B of the computing device 26). This image may be useful for resolving any customer disputes that may later arise. In step 220, when a winning number is determined, the computing device identifies the winning number. This may be done by placement of a marker dolly or by viewing the roulette wheel, for example. Both the image from step 210 and step 220 may be saved in a memory of the computing device for statistical reports purposes.

In step 230, the winning bets are identified, including the color of each winning bet and the number of chips bet for each winning bet. In step 240, if any bets are unclear, a message may be sent to the dealer to reposition the bets to complete analysis so that the chips can be identified and reconstructed by the software program. Step 240 may occur when a possible winning bet is identified, or may occur, as discussed above, before the spin.

In step 250, the payout for each player is determined by the computing device. In step 260, the payouts for each player is displayed to the dealer and/or players so that the dealer can make the appropriate payment to each player.

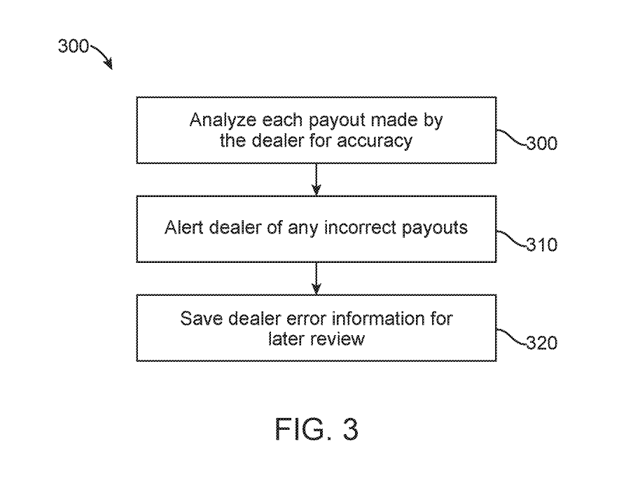

Referring to FIG. 3, in some embodiments, additional steps may be performed for payment verification and dealer correctness and efficiency may be identified. For example, in step 300, each payout may be analyzed for correctness. In step 310, the dealer may be alerted of an incorrect payout at the time of payment. In step 320, in addition to step 310, or in place of step 310, any dealer error may be saved for later review with the dealer.

In some embodiments, the system 20 may track dealer efficiency by calculating the number of games per hour. The system 20 may further be able to determine the efficiency as a function of number or dollar amount of bets placed, thereby providing a normalization of the efficiency calculation for providing the dealer with meaningful feedback on their performance. Earnings per table or per dealer may be determined for statistical purposes. Because the system 20 tracks bets and payouts, the system 20 may be able to determine the profitability of a table game at a certain time of day, at certain locations, or the like.

While the above system and methods are described with respect to roulette, other casino games may benefit from aspects of the present invention. For example, in the game of craps, rolls are often delayed as dealers figure out and make payouts based on a previous roll. By using embodiments of the present invention, payouts may be determined and displayed to the dealer, allowing rapid payment and minimal game delay.

Moreover, while the above system and methods are described with respect to casino games, embodiments of the present invention can be used for broad applications. Thus, embodiments of the present invention provide a solution for learning, memorizing, recognizing, reconstructing and counting objects of the same type placed on a flat surface, such as a casino game layout, identifying each individual color thru image algorithm analysis captured by a video camera using chip learning algorithms, using the results for casino type bets validation.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A system for determining payouts in a casino game, comprising:
a camera capturing images of a betting area of the casino game;
a computing device receiving images captured by the camera;
software stored on non-transient computer readable media on the computing device, the software including programming code to determine winning bets, determine an amount of bet for each of the winning bets, and calculate payouts for each of the winning bets; and
a display at the casino game displaying the payouts for each of the winning bets as calculated by the software.

2. The system of claim 1, further comprising memory for storing the images of the betting area.

3. The system of claim 1, wherein the casino game is roulette.

4. The system of claim 1, wherein the software includes programming code to identify chip color and determine a payout for each chip color.

5. The system of claim 1, wherein the software includes programming code to alert a dealer when the type of bet is unclear, allowing the dealer to confirm the bet with a player and place the bet to a location where the software properly determines whether the bet is a winning bet.

6. The system of claim 1, wherein the software includes programming code to determine whether an amount of a winning bet payout is correct.

7. A method for automatically determining payout in a casino game, comprising:
capturing an image of a betting area of the casino game;
receiving, by a computing device, the image of the betting area;
determining, by analysis of the image by the computing device, one or more winning bets placed in the betting area;
calculating, by the computing device, a payout for each of the winning bets; and
displaying, to a dealer, each separate payout for each of the winning bets, where each payout is identified to a particular player.

8. The method of claim 7, where each player is identified by chip color.

9. The method of claim 7, further comprising saving the image of the betting area in a memory.

10. The method of claim 7, further comprising analyzing, by the computing device, the image of the betting area to locate any unclear bets and informing the dealer of any unclear bets.

11. The method of claim 7, further comprising analyzing payments made by the dealer for each of the winning bets.

12. The method of claim 11, further comprising alerting the dealer when the payments made by the dealer for each of the winning bets does not match the calculated payout for each of the winning bets.

13. The method of claim 7, further comprising a database for storing payout rules for each of a plurality of payouts for the casino game.

14. A method for automatically determining payout in a casino game, comprising:
receiving, by a computing device, an image of a betting area of the casino game;
determining each bet made on the betting area and an amount of each bet;
notifying a dealer if a determination of each bet on the betting area is unclear;
determining, by analysis of the image by the computing device, one or more winning bets placed in the betting area;
calculating, by the computing device, a payout for each of the winning bets; and
displaying, to the dealer, each separate payout for each of the winning bets, where each payout is identified to a particular player.

15. The method of claim 14, where each player is identified by chip color.

16. The method of claim 14, further comprising saving the image of the betting area in a memory.

17. The method of claim 14, further comprising:
analyzing payments made by the dealer for each of the winning bets; and
alerting the dealer when the payments made by the dealer for each of the winning bets does not match the calculated payout for each of the winning bets.
